(19) United States
(12) Patent Application Publication
(10) Pub. No.: US 2012/0020872 A1
(43) Pub. Date: Jan. 26, 2012

(54) HIGH TEMPERATURE REDUCTION OF HYDROGEN PEROXIDE CATALYST FOR IMPROVED SELECTIVITY

(75) Inventors: Sukesh Parasher, Lawrenceville, NJ (US); Michael A. Rueter, Plymouth Meeting, PA (US); Bing Zhou, Titusville, NJ (US)

(73) Assignee: HEADWATERS TECHNOLOGY INNOVATION, LLC, Lawrenceville, NJ (US)

(21) Appl. No.: 12/840,723

(22) Filed: Jul. 21, 2010

(51) Int. Cl. B01J 23/44; C01B 15/01

(52) U.S. Cl. 423/584; 502/339

(57) ABSTRACT

Method for making a direct synthesis hydrogen peroxide catalyst includes (i) mixing together a solvent, a plurality of noble metal catalyst atoms, and a plurality of organic dispersing agent molecules, the organic dispersing agent molecules each including at least one functional group capable of bonding with the noble metal catalyst atoms; (ii) reacting the organic dispersing agent with the catalyst atoms to form complexed catalyst atoms and forming a plurality of catalytic nanoparticles from the complexed catalyst atoms; (iii) supporting the catalytic nanoparticles on a support material; and (iv) reducing the catalyst atoms at a temperature of at least 351° C. to yield a supported and activated direct synthesis hydrogen peroxide catalyst.

### BACKGROUND OF THE INVENTION

1. The Field of the Invention

The present invention relates to the manufacture of supported hydrogen peroxide catalysts made from colloidal nanoparticle solutions.

2. Related Technology

Particulate catalysts are an important component of many industrial applications such as refining, organic synthesis, fine chemicals manufacturing, and many other industrial processes. Many of these catalyzed reactions require the use of precious metals such as platinum and palladium. Much effort has been made to make high performance catalysts that improve product yields for a given amount of precious metal used.

Over a number of years, considerable investigation has been conducted by both industrial and university researchers to develop commercially viable catalysts for the production of hydrogen peroxide by direct reaction of hydrogen and oxygen. The direct synthesis of hydrogen peroxide is expected to have significant economic advantages compared to the conventional method for producing H₂O₂, which is based on the cyclic oxidation and reduction of an anthraquinone working medium. To realize these economic advantages, a catalyst is needed which can catalyze the selective reaction of hydrogen and oxygen to form hydrogen peroxide, while avoiding the undesired production of water.

This is a challenging requirement, as thermodynamic considerations indicate that water is the more likely product.

Direct synthesis catalysts are generally supported precious metal catalysts, with dispersed particles of palladium being the most common selection as the primary active metal. To create active palladium-based catalysts, a useful (and often necessary) step in catalyst synthesis is the reduction of palladium particles. Typically conducted with chemical reducing agent, this procedure aids in the creation of active catalyst sites. Hydrogen is a commonly used reducing agent.

### BRIEF SUMMARY OF THE INVENTION

The present invention provides a method for manufacturing a hydrogen peroxide catalyst with improved selectivity as compared to hydrogen peroxide catalysts manufactured using conventional techniques. The catalysts are manufactured to have improved selectivity by activating the catalyst at a temperature greater than 351° C.

In one embodiment, the method for making a direct synthesis hydrogen peroxide catalyst includes the following steps: (i) mixing together a solvent, a plurality of noble metal catalyst atoms, and a plurality of organic dispersing agent molecules, the organic dispersing agent molecules each comprising at least one functional group capable of bonding with the noble metal catalyst atoms; (ii) reacting the organic dispersing agent with the catalyst atoms to form complexed catalyst atoms and forming a plurality of catalytic nanoparticles from the complexed catalyst atoms; (iii) supporting the catalytic nanoparticles on a support material; and (iv) reducing the catalyst atoms at a temperature greater than 351° C. to yield a supported and activated direct synthesis hydrogen peroxide catalyst.

The methods of the present invention yield a surprising and unexpected result when activating the catalyst at temperatures greater than 351° C. It has been discovered that activating the catalyst at temperatures greater than 351° C. improves selectivity. Further increased selectivity is observed at temperatures greater than 375° C., 400° C., 425° C. and 450° C. This is a surprising and unexpected result because one of skill in the art would expect selectivity to decrease at temperatures greater than about 575 K (301.9° C.) due to sintering. This understanding by those skilled in this art is set forth in a recent article by Lee et. al., published in the well-regarded “Proceedings of The National Academy of Sciences.” (Ileun Lee, et al., “Synthesis of Heterogeneous Catalysts With Well Shaped Platinum Particles To Control Reaction Selectivity,” PNAS vol. 105, pp 15241-15246 (Oct. 7, 2008). Thus, Applicants discovery that improved selectivity can be achieved by increasing the temperature substantially beyond 575 K (301.9° C.) is surprising and unexpected in light of the current thinking by those of skill in the art.

These and other advantages and features of the present invention will become more fully apparent from the following description and appended claims as set forth hereinafter.

### DETAILED DESCRIPTION OF THE PREFERRED EMBODIMENTS

For purposes of the present invention, the term “particle size” refers to average particle diameter and is measured using standard techniques known in the art, including, but not limited to laser diffraction.

The term “nanoparticle” refers to particles having a size between 1 nm and 1000 nm.

### I. COMPONENTS USED TO MAKE METAL-CONTAINING COLLOIDS AND SUPPORTED CATALYSTS

A. Catalytic Metal Ions

Any metals or group of metals suitable for the direct synthesis of hydrogen peroxide can be used so long as the metal atoms can react with the organic agent molecules to form colloids as disclosed herein. The catalytic metals can exhibit primary catalytic activity in the direct synthesis of hydrogen peroxide or can be used as promoters or modifiers.

Primary catalytic metal used in the direct synthesis of hydrogen peroxide include noble metals, such as palladium, platinum, iridium, ruthenium, rhodium, gold, and the like. These may be used alone, in various combinations with each other, or in combinations with other elements, such as base transition metals, alkali metals, alkaline earth metals, rare earth metals, or non-metals.

Examples of rare earth metals that exhibit catalytic activity include, but are not limited to, lanthanum and cerium. These may be used alone, in various combinations with each other, or in combinations with other elements, such as base transition metals, noble metals, alkali metals, alkaline earth metals, or non-metals. Suitable non-transition metals include alkali metals and alkaline earth metals, such as sodium, potassium, magnesium, calcium, etc., and non-metals such as phosphorus, sulfur, oxygen, and halides.

B. Organic Dispersing Agents And Organic Dispersing Agent Molecules

The organic dispersing agent, also referred to as a dispersing agent or an organic agent, is selected to promote the formation of nanocatalyst particles that have a desired size, stability, and/or uniformity for producing hydrogen peroxide. The dispersing agent molecules react with the metal ions to form ligands complexed with the metal ions.

Dispersing agents suitable for bonding metal ions include a variety of small organic molecules, polymers and oligomers. The dispersing agent interacts and bonds with metal ions dissolved or dispersed within an appropriate solvent or carrier. Bonding can occur through various suitable mechanisms including but not limited to, ionic bonding, covalent bonding, lone pair electron bonding, or hydrogen bonding.

To provide the bonding between the dispersing agent molecules and the metal ions, the dispersing agent molecules include one or more appropriate functional groups. In one embodiment, the functional groups comprise a carbon atom bonded to at least one electron-rich atom that is more electronegative than the carbon atom and that is able to donate one or more electrons so as to form a bond or attraction with a metal ion. Preferred dispersing agents include functional groups which have either a charge or one or more lone pairs of electrons that can be used to complex a metal ion. These functional groups allow the dispersing agent to have a strong binding interaction with the metal ions.

In an exemplary embodiment, the functional groups of the dispersing agent comprise one or more members selected from the group of a hydroxyl, a carboxyl, a carbonyl, an amine, an amide, a nitrile, a nitrogen with a free lone pair of electrons, an amino acid, a thiol, a sulfonic acid, a sulfonyl halide, and an acyl halide. The dispersing agent can be monofunctional, bifunctional, or polyfunctional. In a preferred embodiment, the functional group includes at least a carboxyl group.

Examples of suitable monofunctional dispersing agents include carboxylic acids such as formic acid and acetic acid. At least bifunctional dispersing agents are preferred. Useful bifunctional dispersing agents include diacids such as oxalic acid, malic acid, malonic acid, maleic acid, succinic acid, and the like; hydroxy acids such as glycolic acid, lactic acid, and the like. Useful polyfunctional dispersing agents include polyfunctional carboxylic acids such as citric acid and the like. Other useful dispersing agents include 2-mercaptoacetate, amino acids, such as glycine, and sulfonic acids, such as sulfobenzyl alcohol, and sulfobenzoic acid.

Suitable polymers and oligomers within the scope of the invention include, but are not limited to, polyacrylates, polyvinylbenzoates, polyvinyl sulfate, polyvinyl sulfonates including sulfonated styrene, polybisphenol carbonates, polybenzimidizoles, polypyridine, sulfonated polyethylene terephthalate.

In addition to the characteristics of the dispersing agent, it can also be advantageous to control the molar ratio of dispersing agent to the catalyst atoms in a catalyst suspension. A more useful measurement is the molar ratio between dispersing agent functional groups and catalyst atoms. For example, in the case of a divalent metal ion two molar equivalents of a monovalent functional group would be necessary to provide the theoretical stoichiometric ratio. Typically the molar ratio of dispersing agent functional groups to catalyst atoms is preferably in a range of about 0.001:1 to about 50:1. For hydrogen peroxide catalysts the ratio is advantageously in a range of about 0.5:1 to about 40:1, more preferably in a range from about 1:1 to about 35:1, and most preferably in a range of about 3:1 to about 30:1.

The use of the dispersing agent allows for the formation of very small and uniform nanoparticles. In general, the nanocatalyst particles formed in the presence of the dispersing agent are typically less than about 50 nm in size. In some cases, the nanocatalyst particles may be atomically dispersed. The nanocatalyst particles preferably have an average particle size less than about 20 nm, more preferably less than about 15 nm, most preferably less than about 10 nm, and even less than about 5 nm.

Finally, depending on the desired stability of the nanocatalyst particles on the support material, the dispersing agent can be selected to bond (e.g., covalently bond) with the support material so as to anchor or tether the nanocatalyst particles and/or atoms to the support material. While the dispersing agent has the ability to inhibit agglomeration of the nanocatalyst particles in the absence of anchoring, chemically bonding the nanocatalyst particles to the support material through a ligand is a particularly effective mechanism for preventing agglomeration.

Suitable functional groups for bonding with the support are the same types of functional groups as those suitable for bonding to the metal ions. However, dispersing agent molecules can have different functional groups for bonding to the support and also for bonding to the metal ions.

C. Solvents and Chemical Modifiers

The metal ions are prepared in a solution that can be applied to a catalyst support material. The solution can contain various solvents, including water and organic solvents. Solvents participate in catalyst formation by providing a solution for the interaction of metal ions and the dispersing agent molecules. Suitable solvents include water, methanol, ethanol, n-propanol, isopropyl alcohol, acetonitrile, acetone, tetrahydrofuran, ethylene glycol, dimethylformamide, dimethylsulfoxide, methylene chloride, and the like, including mixtures thereof.

Other chemical modifiers may also be included in the liquid mixture. For example, acids or bases may be added to adjust the pH of the mixture. It is also possible to add acids and bases as a solid material. For example, ion exchange resins that have basic or acid functional groups can be used. The solid material can be easily separated from the final colloid using simple techniques such as centrifugation and filtration. Surfactants may be added to adjust the surface tension of the mixture, or to stabilize the nanoparticles.

D. Reducing Agent

A reducing agent is used to reduce the metal ions to a lower oxidation state. Any compound capable of reducing the metal ions can be used. In a preferred embodiment, the reducing agent is hydrogen. Other suitable reducing agents include small organic molecules such as formaldehyde, formic acid, methanol, ethylene, and hydrides such as lithium aluminum hydride and sodium borohydride.

E. Support Materials

The nanocatalyst particles are deposited and/or formed on a support material. The support may be organic or inorganic. It may be chemically inert, or it may serve a catalytic function complementary to the nanocatalyst. The support may be in a variety of physical forms. It may be porous or nonporous. It may be a three-dimensional structure, such as a powder, granule, tablet, or extrudate. The support may be a two-dimensional structure such as a film, membrane, or coating. It may be a one-dimensional structure such as a narrow fiber.

One class of support materials includes porous, inorganic materials, such as alumina, silica, titania, kieselguhr, diatomaceous earth, bentonite, clay, zirconia, magnesia, metal oxides, zeolites, and calcium carbonate. Another useful class of supports includes carbon-based materials, such as carbon black, activated carbon, graphite, fluoridated carbon, and the like. Other supports include polymers and other inorganic solids, metals, and metal alloys.

The nanocatalyst particles can be deposited within a wide range of loadings on the support material. The loading can range from about 0.01% to about 70 wt % of the supported nanocatalyst particles, more preferably in a range of about 0.1% to about 25%. In the case where the support material is porous, it is preferable for the surface area to be at least about 20 m²/g, more preferably at least about 50 m²/g.

### II. METHODS FOR MAKING HYDROGEN PEROXIDE CATALYSTS

The process for manufacturing hydrogen peroxide catalysts according to the present invention can be broadly summarized as follows. First, one or more types of catalytic metal atoms (e.g., in the form of a ground state metal or ionized metal salt) and one or more types of dispersing agent molecules (e.g., in the form of a carboxylic acid salt) are selected. The metal atoms and the dispersing agent molecules are dissolved in a solvent and reacted to form a plurality of complexed metal atoms. The complexed atoms are then caused to form catalysts nanoparticles (e.g. by reducing the metal atoms) and supported on a support material. The catalyst nanoparticles are activated at a temperature greater than 351° C. using a reducing agent.

In a preferred embodiment, the metal atoms are provided as a halogen salt (e.g. palladium chloride) in a solution. In this embodiment, the solution of the metal halogen salt preferably has a low concentration of mineral acid, such as HCl. Preferably, the weight percent acid in the metal salt solution is less than about 15%, and more preferably less than about 10%. Solutions of precious metal salts with low acid concentrations can be prepared or can be purchased commercially (e.g., a palladium solution with 7% w/w free acid (as HCl) can be purchased from Colonial Metals Co.). Minimizing the amount of halogen ions in the catalyst mixture can also be advantageous since halogens can be corrosive to equipment used in manufacturing hydrogen peroxide.

It can be advantageous to control the molar ratio of dispersing agent to the catalyst atoms in a catalyst suspension. A useful measurement is the molar ratio between dispersing agent functional groups and catalyst atoms. For example, in the case of a divalent metal ion two molar equivalents of a monovalent functional group would be necessary to provide the theoretical stoichiometric ratio. Typically the molar ratio of dispersing agent functional groups to catalyst atoms is preferably in a range of about 0.001:1 to about 50:1. For hydrogen peroxide catalysts the ratio is advantageously in a range of about 0.5:1 to about 40:1, more preferably in a range from about 1:1 to about 35:1, and most preferably in a range of about 3:1 to about 30:1.

Once the metal atoms are complexed with the organic agent, the complexed metal atoms are reduced with a reducing agent to form a plurality of nanocatalyst particles dispersed in the solvent, thereby forming a colloid. To form the colloid, the solution may be exposed to the reducing agent for any suitable period of time, including at least a few minutes, at least 30 minutes, at least 1 hour, or even at least six hours. The formation of a colloid is typically evidenced by a color change in the solution (although not required).

After formation of the colloidal nanoparticles, the nanoparticles are supported on a support material having a surface area and composition suitable for supporting hydrogen peroxide catalytic metal particles and suitable for use in a hydrogen peroxide direct synthesis reaction. In a first embodiment, the hydrogen peroxide nanoparticles can be formed or partially formed on the support material or in a second embodiment formed in solution or partially formed in solution and then deposited on a support material. To form the particles in whole or in part in the solution, a reducing agent is applied to the solution before contact is made with a support material. The colloidal particles can be supported on the support material by impregnating the support with the colloidal solution. This embodiment may be used when it is desired that the support material not influence the formation of the nanoparticles.

In an alternative embodiment, the nanoparticles may form in the presence of the support material. In this embodiment, the support material is impregnated with the solution of complexed catalyst atoms (i.e., prior to particle formation). The reduction is then carried out with the catalyst atoms in the presence of the support material to yield particles on the support material.

Depending on the physical form of the solid support, the process of contacting or applying the nanocatalyst solution to the support may be accomplished by a variety of methods. For example, the support may be submerged or dipped into the nanocatalyst solution. Alternatively, the nanocatalyst solution may be sprayed, poured, painted, or otherwise applied to the support, such as by incipient wetness impregnation. Thereafter, the solvent or carrier is removed.

Metal loadings of the catalyst component on the support material can vary. In a preferred embodiment, the metal loading is between about 0.01% and about 10% by weight, and more preferably between about 0.05% and about 5% by weight. These loading amounts are useful for catalysts for direct synthesis of hydrogen peroxide, for example. In many cases it can be advantageous to have metal loadings of at least about 0.1 wt %.

In either case (i.e., particle formation before or after contact with the support) supporting the nanoparticles on the support material includes drying or otherwise removing the solvent to yield a dry supported catalyst. The solvent can be removed by decanting and/or evaporating the solvent and/or otherwise drying. The drying temperature may be any temperature suitable for removing the solvent. For example, where the solvent includes water, the drying temperature would typically be between 50° C. and 100° C. Other temperatures may be used depending on the solvent mixture and/or pressure. Drying can be carried out for any length of time necessary to remove the solvent.

The activation step is performed on the dry supported catalyst using a reducing agent. Any reducing agent can be used that will reduce the metal and can be removed or used without interference in subsequent hydrogen peroxide manufacturing processes. Reduction using hydrogen is typically preferred for its ease of use (i.e., by virtue of being a gas). To reduce the complexed catalyst atoms using hydrogen, the supported catalyst should be purged with an inert gas to remove oxygen thereby avoiding undesired burning or combustion of the hydrogen.

A critical and essential aspect of the invention is the elevated temperature used during the activation step to produce a catalyst with the desired activity and selectivity. In one embodiment, the temperature at which the catalyst is reduced is at least 351° C., preferably at least 375° C., and more preferably at least 400° C. Higher temperatures may also be used. In some embodiment, the reducing temperature can be at least 425° C., 450° C. or even at least 500° C. In one embodiment, the reducing temperature may be in a range from 351° C. to 700° C., alternatively in a range from 375° C. to 600° C., or even in a range from 400° C. to 500° C. As discussed above, and as further evidenced by the examples below, it has been found that these elevated temperatures surprisingly yield a hydrogen peroxide catalyst with improved selectivity as compared to similar catalysts reduced at lower activation temperatures, contrary to the teaching of those skilled in the art, which teach that heating the catalyst to temperatures higher than 575 K (301.9° C.) reduces selectivity.

In one embodiment the method yields supported hydrogen peroxide catalysts with relatively high selectivity. In one embodiment the methods yield hydrogen peroxide catalysts with a selectivity of at least 67 (moles/hour of H₂O₂ produced)/(moles/hour H₂O₂ produced+moles/hr water produced, preferably at least 68, and more preferably at least 69.

The methods of forming the supported catalyst according to the invention can also yield extremely small and uniform particles, despite the high activation temperatures. The catalyst particles may have a particle size less than 50 nm, less than 20 nm, less than 15 nm, less than 10 nm, or even less than 5 nm.

### III. METHODS OF MANUFACTURING HYDROGEN PEROXIDE

The supported catalysts of the present invention are particularly advantageous for the direct synthesis of hydrogen peroxide from hydrogen and oxygen. In a preferred embodiment, hydrogen peroxide promoting catalysts manufactured according to the present invention include a combination of palladium and platinum.

The catalysts of the present invention can be used in any type of reactor suitable for the direct synthesis of hydrogen peroxide. Suitable reactors include fixed bed, ebullated bed, and slurry reactors. In a preferred embodiment, the catalysts of the present invention are loaded into a fixed bed or ebullated bed reactor for hydrogen peroxide production. The use of the catalysts of the present invention in a fixed bed or ebullated bed reactor facilitates the recovery and regeneration of the catalyst.

To load the catalysts in a fixed bed or ebullated bed reactor, the supported catalysts are manufactured to have a size and/or shape suitable for a fixed bed or ebullated bed. For example, the supported catalysts can be manufactured into particulates such as beads or spheres that have a size suitable for use in a fixed bed or fluidized bed reactor. In an example embodiment, the particulate has a nominal dimension of at least about 0.5 mm, and more preferably at least about 1 mm. Alternatively, the support material can be extruded to make a part with dimensions that are suitable for use in any size or shaped fixed bed reactor.

Extruding, crushing or otherwise shaping the support material for use in a particular type of reactor is typically done before supporting the nanocatalyst onto the support material such that the nanoparticles are distributed over substantially the entire support surface that is exposed in the reactor.

Once the supported catalyst is placed into a suitable reactor, hydrogen peroxide can be directly synthesized by introducing a feedstream of hydrogen gas and molecular oxygen. The hydrogen and oxygen are introduced into the reactor with a solvent. The solvent can include water and/or an organic solvent. In one embodiment the organic solvent may be an alcohol such as methanol. The feedstream may also include a halide source. In a preferred embodiment the halide source includes bromide (e.g., NaBr).

In an exemplary embodiment, hydrogen is introduced into the reactor in a concentration less than the flammability limit of hydrogen. The oxygen concentration preferably ranges from about 5% to about 97% by volume, more preferably from about 10% to about 80%, and most preferably from about 20% to about 60%. For concentrations of oxygen greater than about 25%, it is advantageous to use an inorganic support to avoid oxidation of the support (e.g., silica gel).

The supported catalysts of the present invention have metal loadings and suitable activity and selectivity for the efficient production of hydrogen peroxide at low hydrogen concentrations.

### IV. EXAMPLES

The following examples provide formulas for making precursor solutions, colloidal solutions, containing complexed metal catalyst atoms, colloidal solutions of metal nanoparticles, supported and activated hydrogen peroxide catalysts, and methods for making hydrogen peroxide using the catalysts.

### Example 1

### Precursor Solution

Example 1 describes a method for preparing a precursor solution of platinum and palladium ions complexed with a polyacrylate.

A first solution of Pd metal atoms was prepared by mixing 0.657 g of an aqueous PdCl₂ solution (containing 15.22 wt % Pd) and 0.6623 g of aqueous H₂PtCl₆ solution (containing 0.302 wt % Pt) and diluting with dionized water to a total weight of 50 g. A second solution was prepared by diluting 2.5 g of a 45 wt % aqueous solution of sodium polyacrylate (molecular weight=1200) to a total weight of 50 g with deionized water.

The precursor solution was prepared by mixing the first and second solutions. The precursor solution was then purged with nitrogen at 100 ml/min for 2 hr, and then fed with hydrogen at 100 ml/min for 2 hrs. The precursor solution was then allowed to stand overnight with stirring.

The support material used was a coated silica gel, supplied in the foriri of 1-2 mm spherical beads by St.-Gobain, under the trade name Norpro. The catalyst support material (50 g dry weight) was mixed with 100 g of the precursor solution. The mixture was placed in a rotating drier apparatus and continuously rotated while heating until the liquid evaporated. The catalyst was allowed to continue drying in the apparatus for an additional 30 minutes. Additional drying was then completed in a drying oven at 110° C. for 6 hrs. The process yielded a supported hydrogen peroxide catalyst including 0.2 wt % Pd and 0.004 Pt. The supported hydrogen peroxide catalyst of Example 1 was then activated using various different parameters as described in Examples 2-5 below.

### Example 2

### 300° C./17 hours (Comparative Example)

Example 2 describes activation of the catalyst prepared according to Example 1. The dried solid prepared according to the method of Example 1 was treated in a tubular reactor with 5% hydrogen/Nitrogen at 100 ml/min at a temperature of 300° C. for 17 hours.

### Example 3

### 400° C./5 hours

Example 3 describes activation of a catalyst prepared according to Example 1. The dried solid prepared according to the method of Example 1 was treated in a tubular reactor with 5% hydrogen/Nitrogen at 100 ml/min at a temperature of 400° C. for 5 hours.

### Example 4

### 450° C./5 hours

Example 4 describes activation of a catalyst prepared according to Example 1. The dried solid prepared according to the method of Example 1 was treated in a tubular reactor with 5% hydrogen/Nitrogen at 100 ml/min at a temperature of 450° C. for 5 hours.

### Example 5

### 450° C./10 hours

Example 5 describes activation of a catalyst prepared according to Example 1. The dried solid prepared according to the method of Example 1 was treated in a tubular reactor with 5% hydrogen/Nitrogen at 100 ml/min at a temperature of 450° C. for 10 hours.

### Examples 6-9

### Direct Synthesis of Hydrogen Peroxide

Examples 6-9 describe the direct synthesis of hydrogen peroxide using the catalyst manufactured according to Examples 2-5, respectively. The catalyst from Examples 2-5 was packed into a vertical tubular fixed bed reactor of 6 mm inside diameter. A liquid feed consisting of methanol containing 4 wt % water, 650 ppm (by weight) of sulfuric acid and 15 ppm (by weight) of NaBr was fed to the bottom of the reactor at a total rate of 8 g/hr. A gas feed containing 3% hydrogen, 18% oxygen, and the balance inert gas was also fed to the bottom of the reactor at 424 standard ml/min. Liquid and gas products were withdrawn from the top of the reactor. Liquid was analyzed for hydrogen peroxide concentration by permanganate titration and for water content by Karl Fischer titration. The liquid feed was sampled and analyzed for water content by Karl Fischer titration. The gaseous effluent from the reactor was analyzed by GC for hydrogen concentration. Selectivity was calculated according to the following equation:

% Selectivity=(moles/hour H₂O₂ produced)/(moles/hour H₂O₂ produced+moles/hr water produced)

The Results of the hydrogen peroxide production are provided in Table 1 below.

| | | Catalyst | H₂ | H₂O₂ | Prod. | |
|---|---|---|---|---|---|---|
| | | Charge | Conv. | Conc. | (g H₂O₂/g | Select. |
| | Catalyst Description | (g) | (%) | (wt %) | Pd/hr) | KF |
| Example 6 | Reduced at 300° C. for 17 hr | 0.7833 | 62 | 6.7 | 344 | 66 |
| Example 7 | Reduced at 450° C. for 5 hr | 0.7875 | 60 | 6.5 | 346 | 69.7 |
| Example 8 | Reduced at 450° C. for 10 hr | 0.7843 | 56 | 6.16 | 325 | 69 |
| Example 9 | Reduced at 400° C. for 5 hr | 0.7821 | 61 | 6.9 | 355 | 69.8 |

As shown table 1, reduction at temperatures substantially greater than 300° C. had the opposite effect on selectivity compared to what one of ordinary skill in the art would expect. Specifically % selectivity was consistently improved by 3% when reducing at 400° C. and 450° C. as compared to a catalyst reduced at 300° C. This result is surprising and unexpected for catalyst manufactured using an organic dispersing agent since it would be expected that the controlled particle formation achieved using the dispersing agent would be partially destroyed at temperatures beginning at 300° C. and would result in poorer selectivity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for making a direct synthesis hydrogen peroxide catalyst having a high selectivity, comprising:
(i) mixing together a solvent, a plurality of noble metal catalyst atoms, and a plurality of organic dispersing agent molecules, the organic dispersing agent molecules each comprising at least one functional group capable of bonding with the noble metal catalyst atoms;
(ii) reacting the organic dispersing agent with the catalyst atoms to form complexed catalyst atoms and forming a plurality of catalytic nanoparticles from the complexed catalyst atoms;
(iii) supporting the catalytic nanoparticles on a support material; and
(iv) reducing the catalyst atoms at a temperature greater than 351° C. to yield a supported and activated direct synthesis hydrogen peroxide catalyst.

2. A method as in claim 1, wherein the reduction is carried out at a temperature greater than 375° C.

3. A method as in claim 1, wherein the reduction is carried out at a temperature greater than 400° C.

4. A method as in claim 1, wherein the reduction is carried out at a temperature greater than 450° C.

5. A method as in claim 1, wherein the reduction is carried out for a period of time of at least about 1 hour.

6. A method as in claim 1, wherein the reduction is carried out for a period of time of at least about 4 hour.

7. A method as in claim 1, wherein the reduction is carried out using an organic reducing agent, hydrogen gas, or a combination thereof.

8. A method as in claim 1, wherein the median size of the nanoparticles is less than about 50 nm.

9. A method as in claim 1, wherein the median size of the nanoparticles is less than about 10 nm.

10. A method as in claim 1, wherein the functional group includes a carboxyl moiety.

11. A method for making hydrogen peroxide comprising:
preparing a catalyst according to the method of claim 1; and
reacting hydrogen and oxygen together to produce hydrogen peroxide using the catalyst.

12. A supported catalyst manufactured according to the method of claim 1, the catalyst having a % selectivity of at least about 67 (moles/hour of H₂O₂ produced)/(moles/hour H₂O₂ produced+moles/hr water produced).

13. A supported catalyst as in claim 12, wherein the % selectivity is at least 68.

14. A method for making a direct synthesis hydrogen peroxide catalyst, comprising:
(i) mixing together water, a plurality of catalyst atoms including palladium, and a plurality of organic dispersing agent molecules, each organic dispersing agent molecule comprising at least one functional group capable of bonding with the noble metal catalyst atoms;
(ii) reacting the organic dispersing agent with the catalyst atoms to form complexed catalyst atoms and forming a plurality of catalytic nanoparticles from the complexed catalyst atoms;
(iii) supporting the catalytic nanoparticles on a silica support material; and
(iv) reducing the catalyst atoms with hydrogen gas at a temperature greater than 375° C. to yield a supported and activated direct synthesis hydrogen peroxide catalyst.

15. A method as in claim 14, wherein the reduction is carried out at a temperature greater than 400° C.

16. A method as in claim 14, wherein the reduction is carried out at a temperature greater than 450° C.

17. A method as in claim 15, wherein the organic dispersing agent includes polyacrylic acid.

18. A method as in claim 15, wherein the hydrogen is passed through the mixture for a period of time greater than about 1.0 hour.

19. A supported catalyst manufactured according to the method of claim 15, the catalyst having a % selectivity of at least 67 (moles/hour of H₂O₂ produced)/(moles/hour H₂O₂ produced+moles/hr water produced).

20. A supported catalyst as in claim 20, wherein the % selectivity is at least 68.
